(19) United States
(12) Patent Application Publication
(10) Pub. No.: US 2001/0004182 A1
(43) Pub. Date: Jun. 21, 2001

(54) Glove box

(76) Inventor: Stewart Bennison, Chesterfield (GB)

Correspondence Address: TREXLER, BUSHNELL, GIANGIORGI & BLACKSTONE, LTD., 105 W. ADAMS STREET, CHICAGO, IL, 60603, US

(21) Appl. No.: 09/736,892

(22) Filed: Dec. 13, 2000

(30) Foreign Application Priority Data
Dec. 14, 1999 (GB) 9929415.9

(51) Int. Cl. B08B 15/00

(52) U.S. Cl. 312/1

(57) ABSTRACT

A glove box (1) comprises a chamber (4) provided with a front wall (24) having an operator's viewing panel (25) having a horizontally extending, elongated slot (26) to which is sealingly secured a flexible material or fabric (27) impervious to the hazardous material to be handled within the glove box (1) and comprising a horizontally extending, elongated mouth (28) leading to two spaced-apart elongated gloves or gauntlets (29) adapted to receive the forearms and hands of the operator (16).

### FIELD OF THE INVENTION

This invention relates to a glove box for the handling of hazardous materials.

### BACKGROUND OF THE INVENTION

Conventional glove boxes comprise a sealed chamber, normally at negative pressure into which containers containing a hazardous material are individually loaded through an openable and closeable door system with, after loading, the container manually opened by an operator with a view to emptying the contents from the container. A conventional container comprises a lidded drum, with the hazardous material contained within a flexible bag usually of synthetic plastics located inside the drum, the bag having a tied neck or heat-sealed top. Consequently, the operator is required to unclip the lid, remove the lid and then to untie or slit the bag ready for removal of the contents by mechanised inversion of the drum. Conventionally, the glove box is provided with a front wall at which the operator stands, the wall incorporating a viewing panel and a pair of elongated gloves or gauntlets sealingly attached one to each of two horizontally spaced-apart, circular boles in the front wall. It will be appreciated that if all operators were of the same physical stature then location of the circular holes at a suitable height and spacing as well as elongated gloves of optimum length, could be achieved. However, due to the restrictions implicit in the current system which restrict the hand and arm manoeuvres that an operator can achieve, it is frequently necessary to provide on a side wall of the glove box a duplicate viewing panel, elongated gloves etc., so that operations that cannot be performed from the frontal position can possibly be performed from a side position.

### OBJECT OF THE INVENTION

A basic object of the invention is the provision of an improved glove box providing for greater maneuverability of the operator's hands and forearms thereby reducing if not eliminating the constraints on operations resulting from prior art glove boxes and the frequent need to duplicate the viewing panel etc., at a sidewall.

### SUMMARY OF THE INVENTION

According to the present invention, there is provided a glove box comprising a chamber provided with a front wall having an operator's viewing panel characterized in that the front wall has a horizontally extending, elongated slot to which is sealingly secured a flexible material or fabric impervious to the hazardous material to be handled within the glove box and comprising a horizontally extending, elongated mouth leading to two spaced-apart elongated gloves or gauntlets adapted to receive the operator's forearms and hands.

### ADVANTAGES OF THE INVENTION

Save for the selection of the height at which the elongated slot is located the glove box in accordance with the invention does not require a predetermined and fixed location of two access holes in the front wall and consequently far greater arm maneuverability is possible than with prior art proposals and obviating the need to provide a second glove box orthogonal to the first.

### PREFERRED OR OPTIONAL FEATURES OF THE INVENTION

The viewing panel and elongated slot are provided in a sub-assembly of the front wall that can, within limits, be advanced and retracted to aid from the operator, under the control of the operator to provide an increased range of access to the interior.

The sub-assembly is sealingly attached to the front wall by a peripheral bellows or other flexible connector.

Link arrangements at opposite ends of the sub-assembly and connected between the sub-assembly and the front wall, support the weight of the sub-assembly from the front wall.

Each link arrangement comprises upper and lower pairs of links, with first links of each pair pivotally attached at one end to the front wall with second links of each pair pivotally attached at one end to the sub-assembly, and with the other end of each link secured to one another by a common pivot, all pivotal connections having a vertical axis, to provide not only for linear in and out movements, but also angled movement, as required by the operator.

The slot is an oval slot.

The chamber is a sealed chamber.

The glove box comprises a main chamber in which discharge of the contents of a container is effected and a loading/unloading chamber between which chamber a container is transferred.

Both chambers have access doors that are interlocked whereby opening of the loading/unloading chamber door firstly permits insertion of a full container into the loading chamber, with the main chamber door in a closed condition, and closing of the loading/unloading chamber door after loading permits opening of the main chamber door for transfer of the container from the loading chamber to the main chamber, with reverse of this procedure to remove an emptied container.

The main chamber door is a vertical, slide door.

The vertical slide door is powered by a pneumatic ram.

The loading/unloading chamber door is secured by shoot bolts the position of which determines whether the main chamber door can or cannot be opened.

Transfer of a full container from the loading/unloading chamber to the main chamber, and of an emptied container from the main chamber to the loading/unloading chamber is effected by a carriage and rail system.

The carriage and rail system incorporates a powered transfer device, e.g. a pneumatic ram.

The main chamber incorporates an elevator and inventor system for the container whereby after elevating the container in a first stage until the container top or lid is at a convenient working height for the operator, the operator unclips and removes the lid and unties or slits the inner bag after which the operator again activates the system to perform the second stage of further elevating and then invert the container to achieve discharge of the contents.

The elevator and inverter system incorporates a rod or probe adapted to project into the opened bag to ensure retention of the hag within the container during inverted discharge.

The elevator incorporates a “U”-shaped cradle so as not to impede discharge of the material of the containers.

The loading/unloading chamber incorporates wash down means, whereby an emptied container that has been re-lidded in the main chamber is washed down in the loading/unloading chamber before removal from the latter.

Pump means are provided to provide the interior of the glove box at a sub atmospheric pressure.

### BRIEF DESCRIPTION OF THE DRAWINGS

One example of a glove box in accordance with the invention is shown by way of example in the accompanying drawings, in which:

FIG. 1 is a side elevation of a glove box in accordance with the invention, and associated upstream and downstream apparatus;

FIGS. 2A and 2B correspond to a portion of FIG. 1 to a larger scales aid from another side, and show respectively the outer and inner positions of the front wall sub-assembly;

FIG. 3 is a front elevation of FIG. 1;

FIG. 3A is an enlargement of a portion of FIG. 3;

FIG. 3B is a plan view of FIG. 3A;

FIG. 4 is a side elevation of FIG. 3;

FIG. 5 is a side elevation of the glove box showing the elevator system;

FIG. 6 is a diagrammatic plan view of the lifting cradle,

FIG. 7 corresponds to FIG. 6 but shows additional features;

FIG. 8 corresponds to FIG. 5 but shows inversion; and

FIG. 9 shows a ram and linkage means to achieve inversion.

### DETAILED DESCRIPTION OF THE DRAWINGS

A glove box 1 particularly for the handling of hazardous materials and specifically for the emptying into processing apparatus associated with the glove box 1 of hazardous materials contained in initially closed containers 2, comprises a main chamber 3 and an adjacent loading/unloading chamber 4 for containers 2. In a known manner, the chambers 3, 4 are connected to a vacuum system to create a sub-atmospheric pressure with an airtight interconnecting door 5 between the chambers 3 and 4, and an airtight extending door 6 of the chamber 4.

Full containers 2 are supplied by the loading/unloading chamber 4 by a vacuum lifting gripping head 7 of an inverted ‘I’-arm 8 supported from an extensible and retractable bellows 9, again vacuum operated in a well known manner, with the upper end of the bellows supported from an overhead gantry 10, with an operators handle 11 and control valve 12.

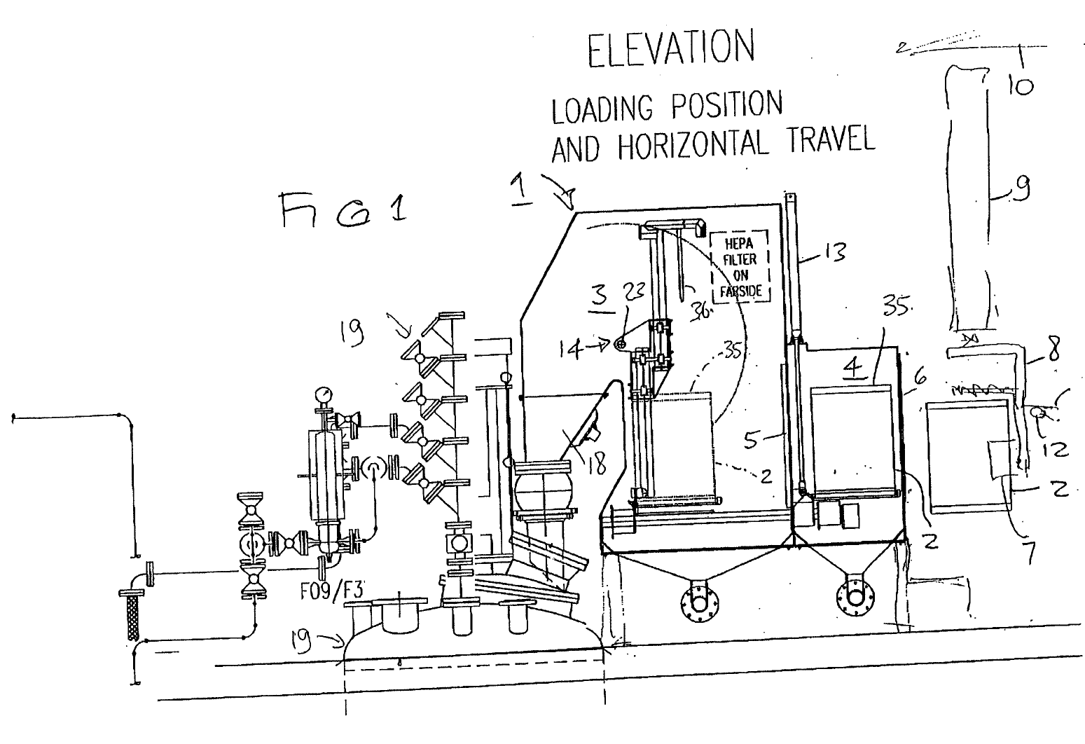

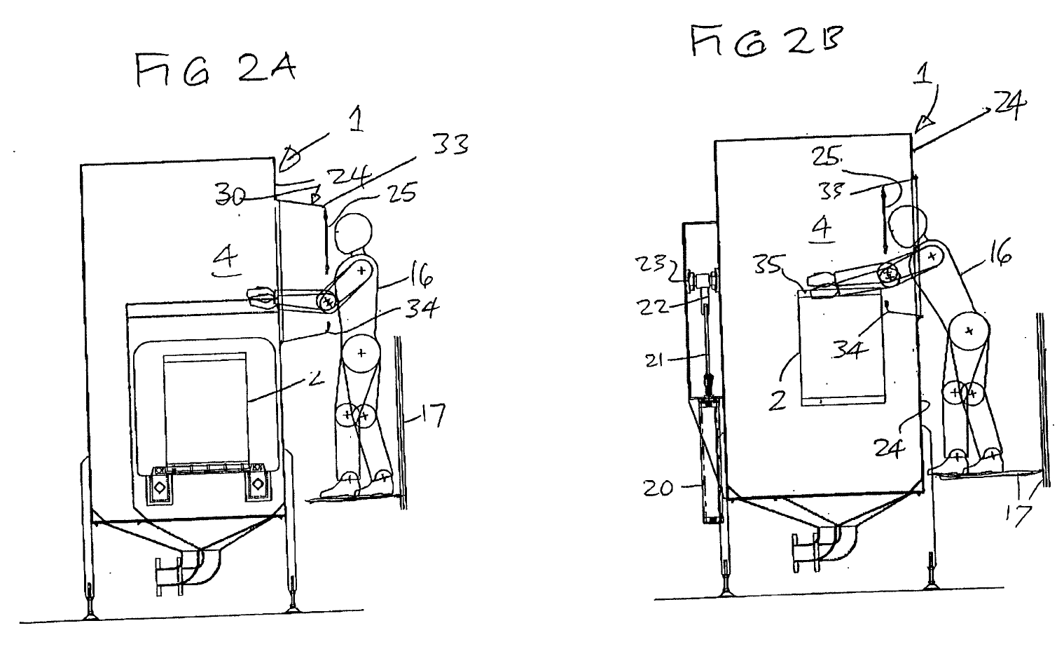

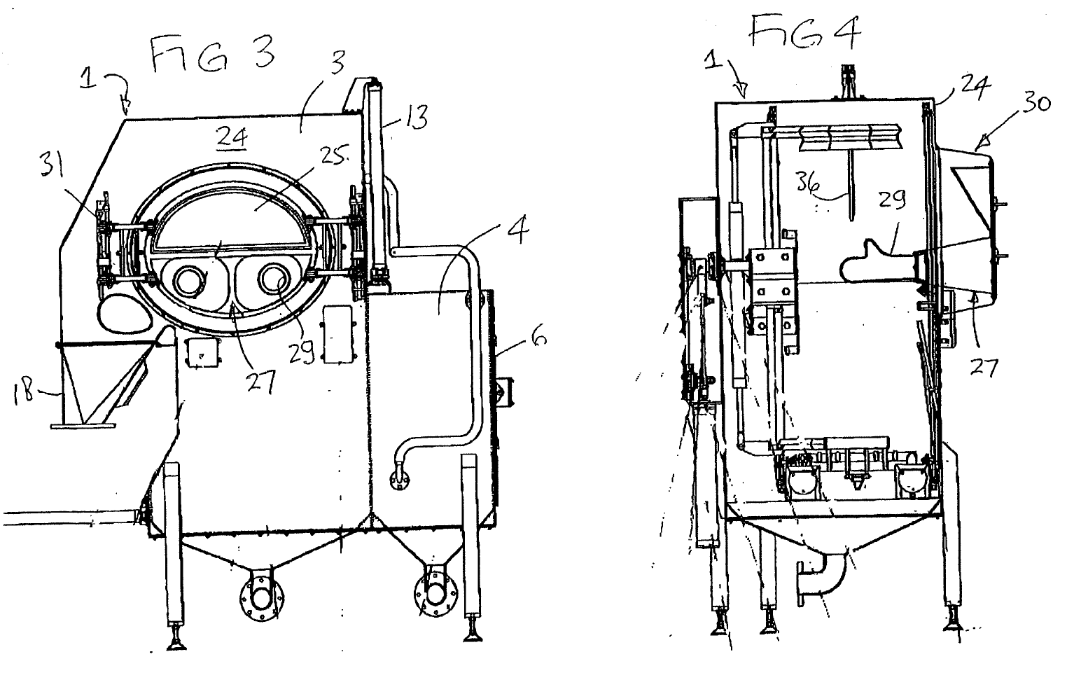

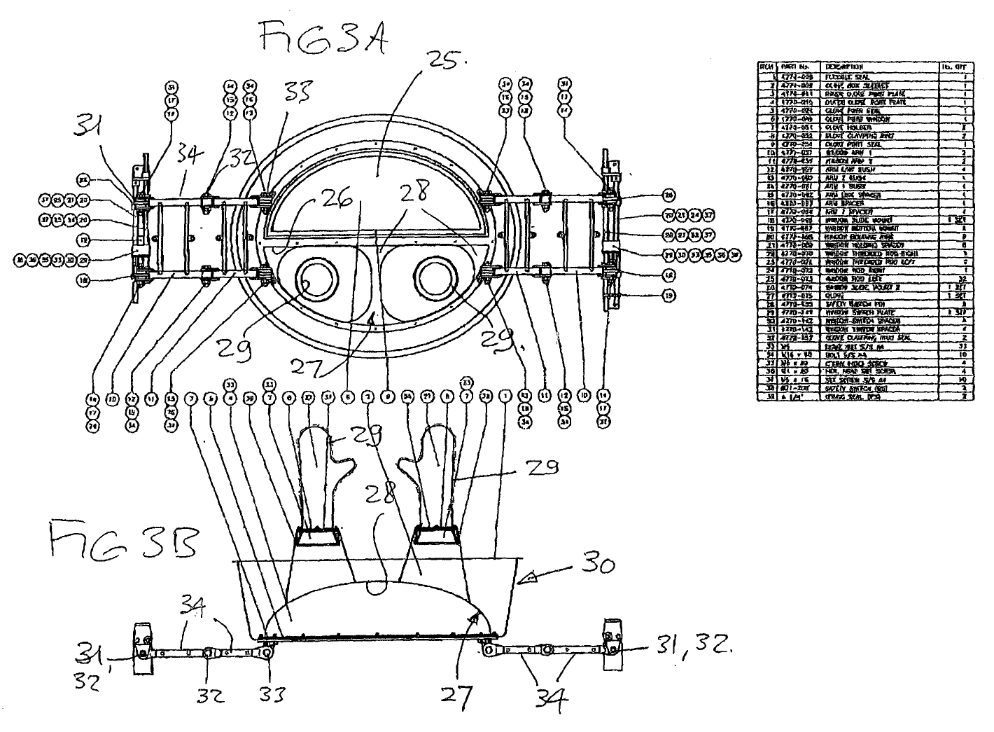

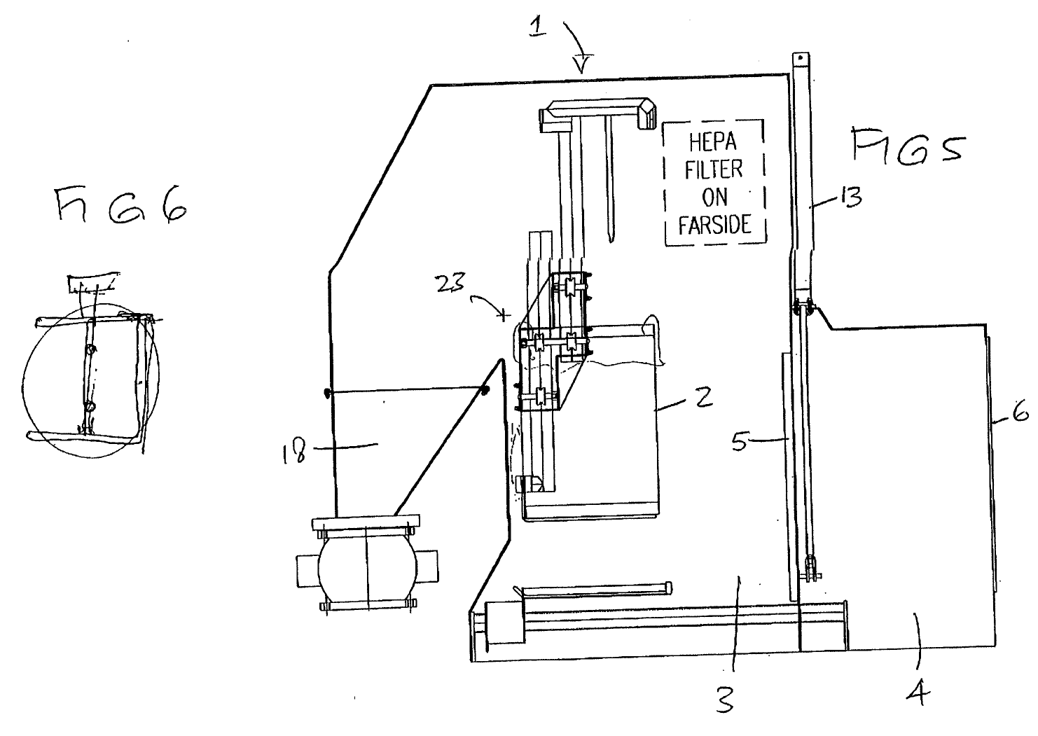

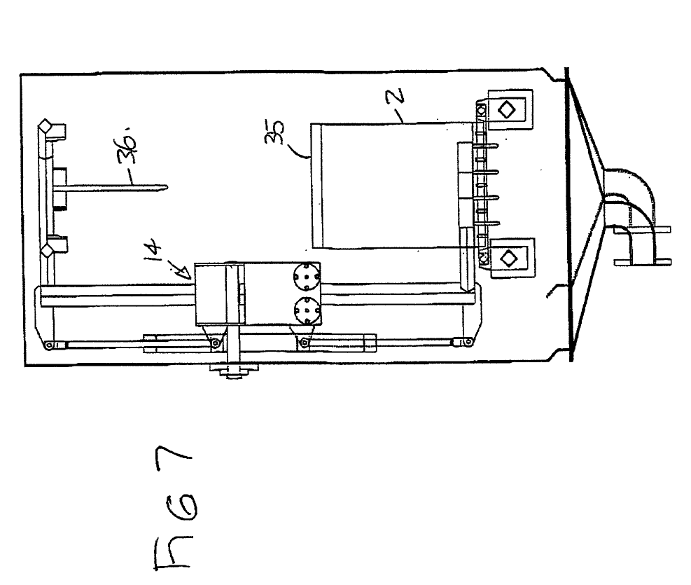

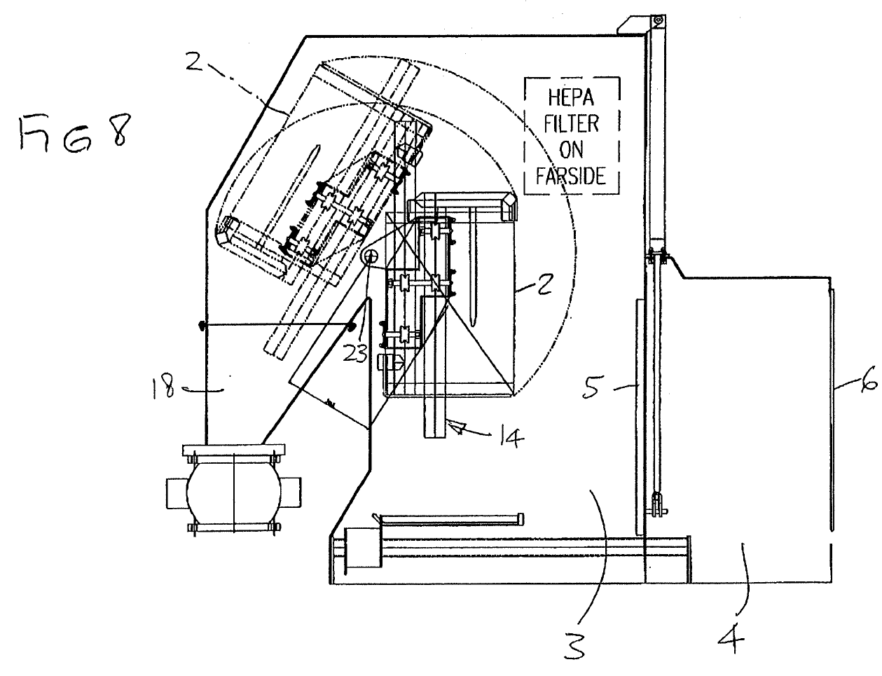

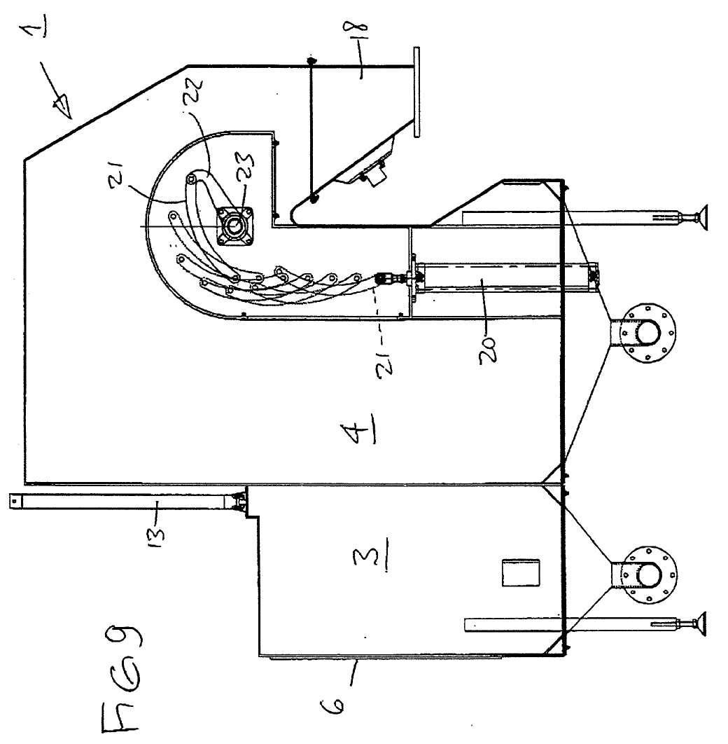

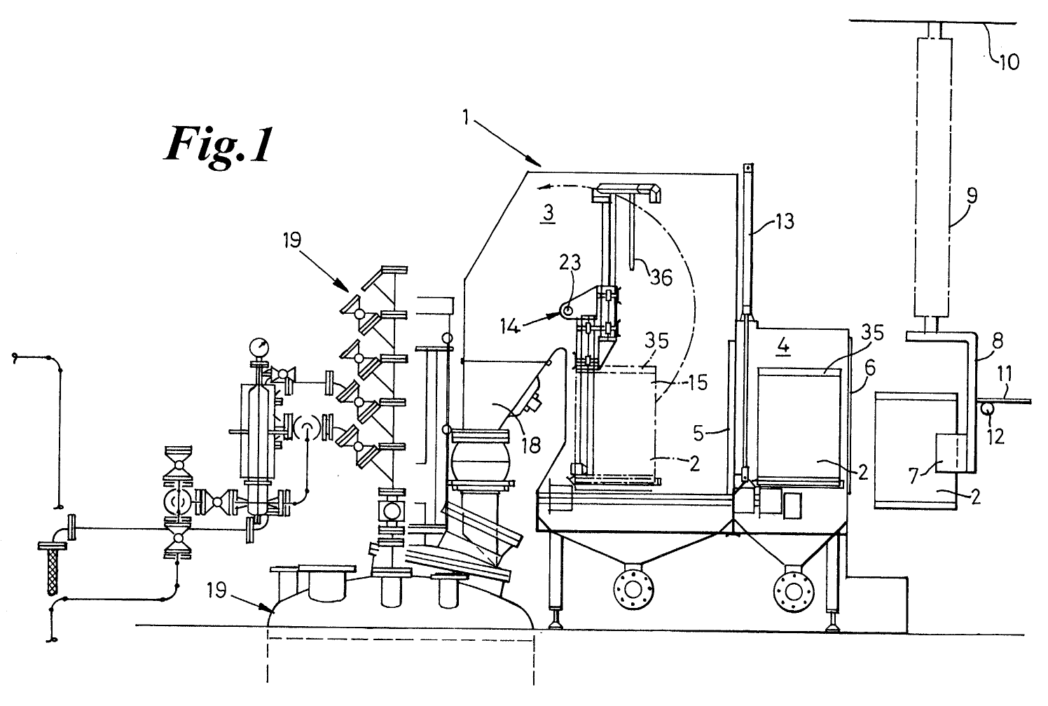

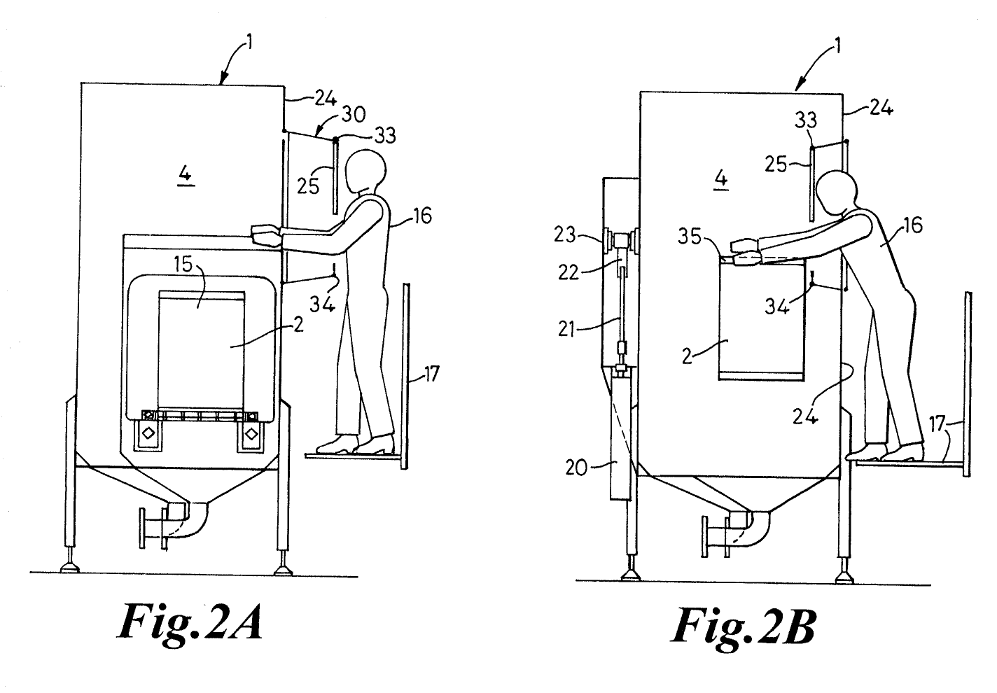

With the external door 6 opened under the control of the operator (and subject to various interlocks) the operator manoeuvres a full container 2 into the loading/unloading chamber 4 as illustrated in FIG. 1. The door 6 is then closed and the vacuum applied. When the required negative pressure is reached, the interconnecting door 5 is lifted from the closed position illustrated in FIG. 1 to its open position by retraction of the pneumatic ram 13 and the container 2 is transferred to the main chamber 3, as illustrated in chain-dotted line in FIG. 1, and in full line in FIG. 2A.

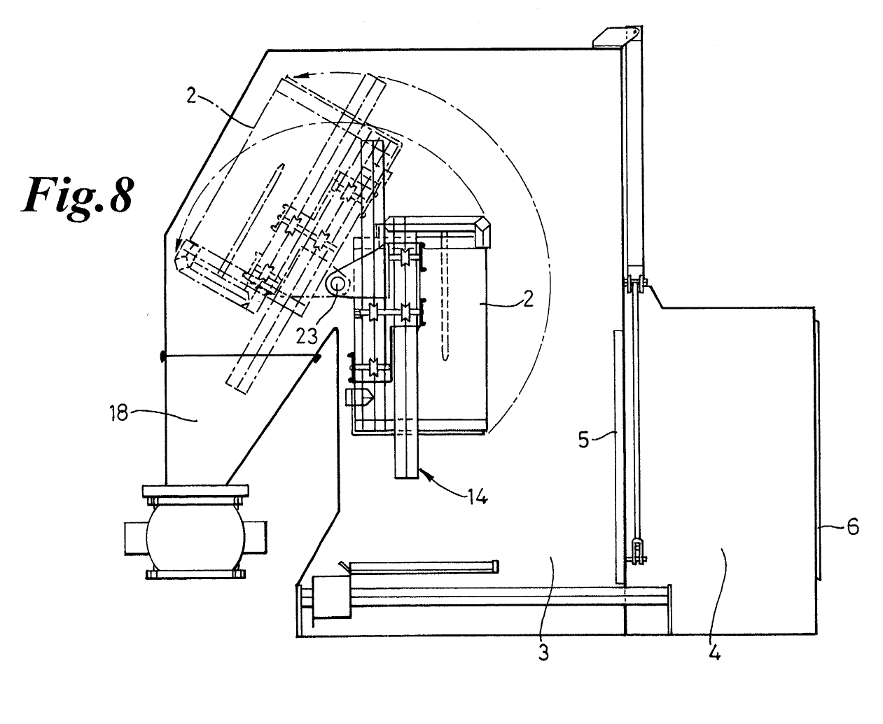

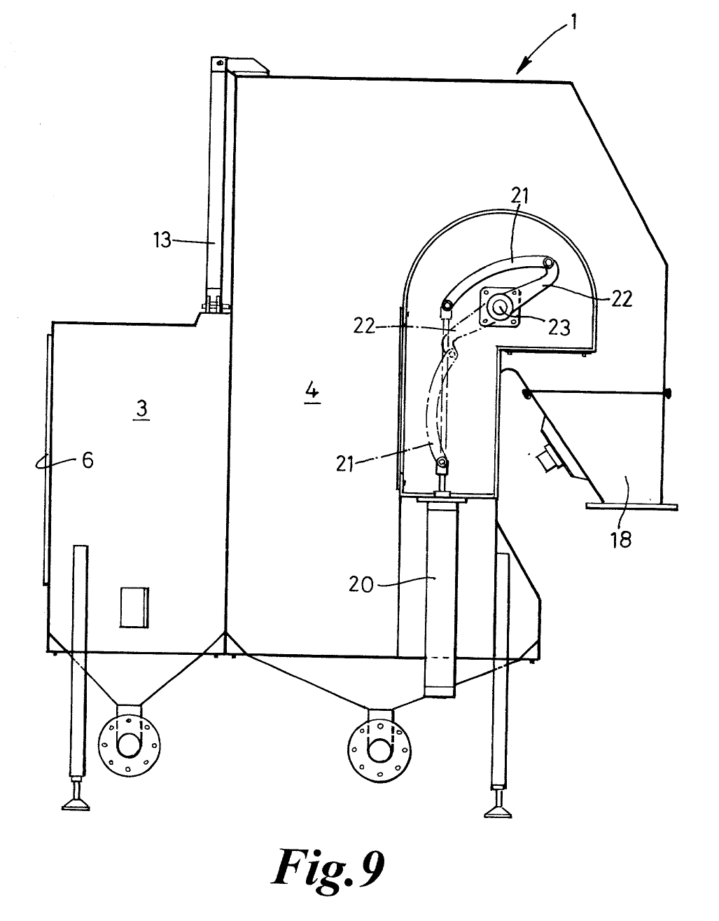

The main chamber 3 contains a mechanism 14 firstly for elevating the container 2 to the position illustrated in FIG. 2B where upper end 15 of the container is accessible to an operator 16 standing on an elevated platform 17 for opening the container 2, following which the mechanism 14 inverts the container 2 for discharge of its contents into a chute 18 of downstream processing equipment 19 as indicated in FIG. 8, using the ram 20, curved lever 21 and bell-crank 22 connected to torque shaft 23.

The manoeuvring of an empty container 2 is then reversed so that the empty container may be removed by the gripping head 7.

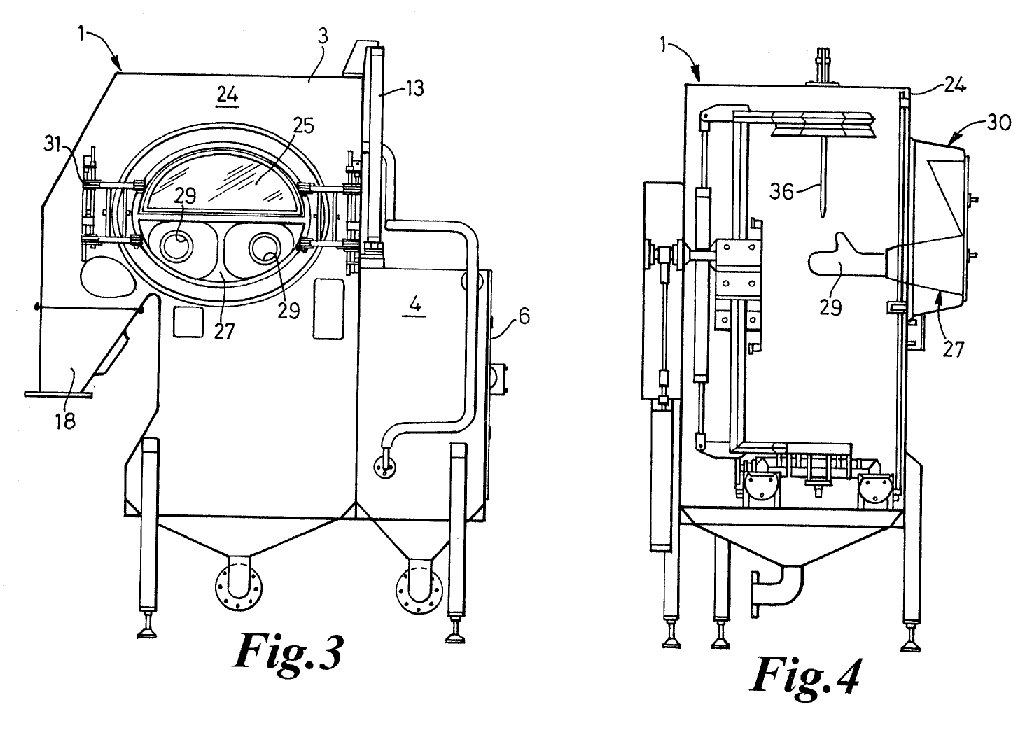

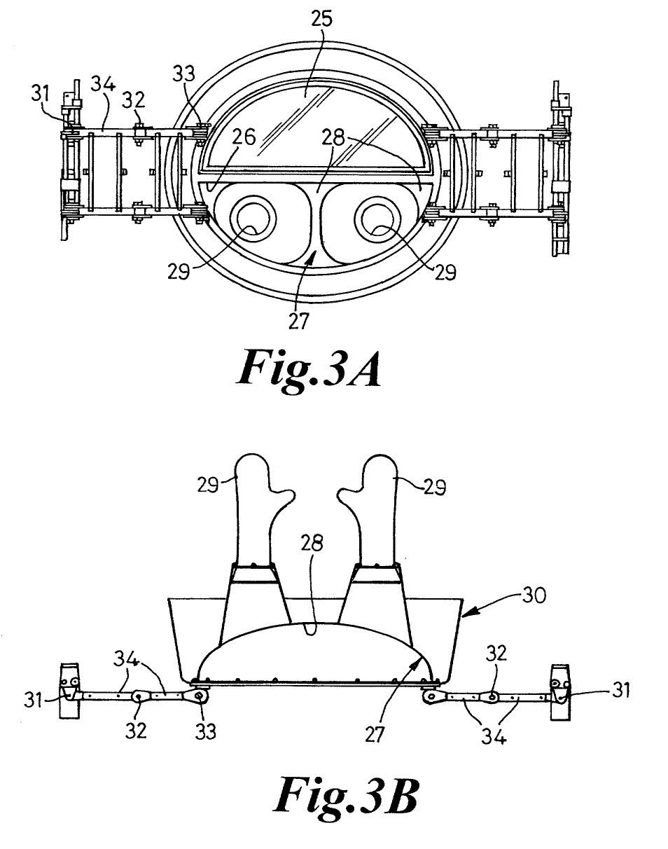

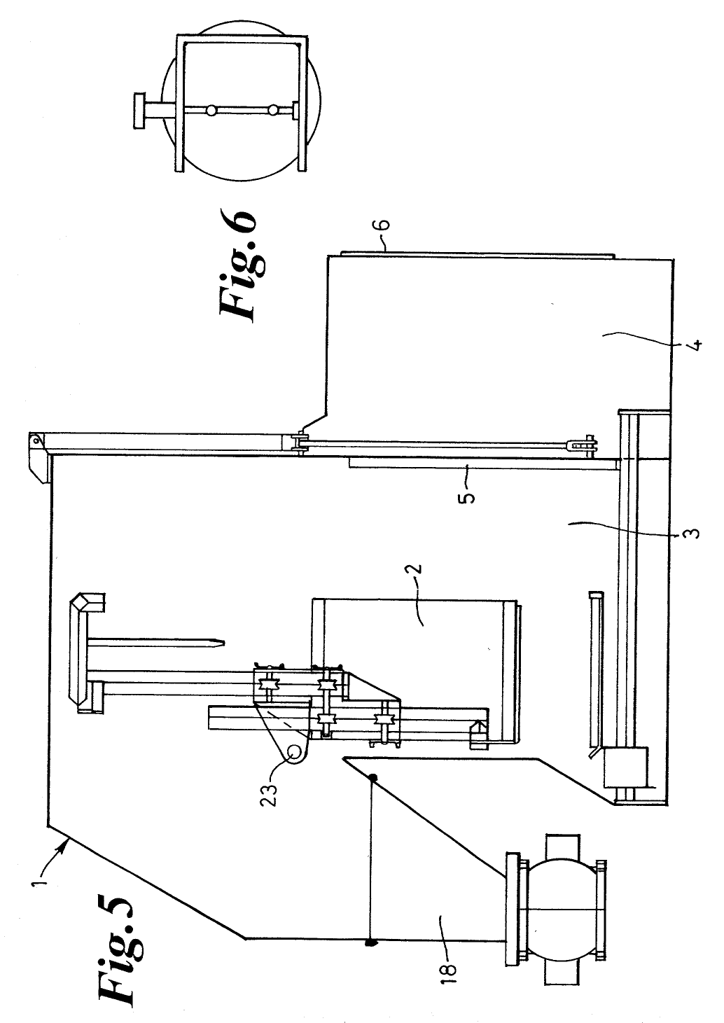

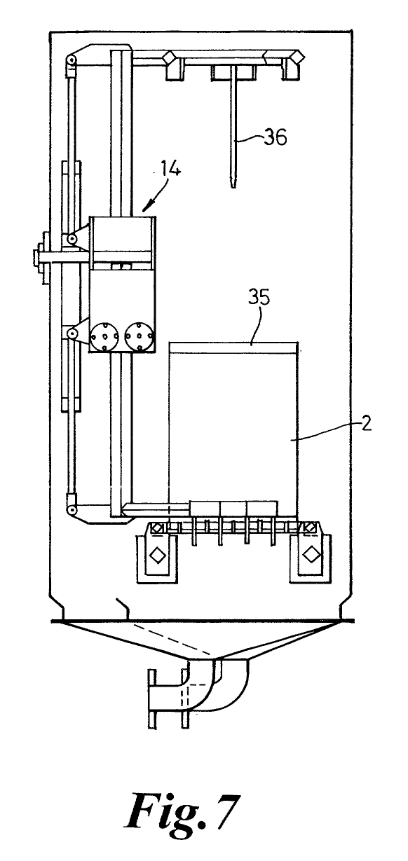

In accordance with the invention, and as best seen in FIGS. 2A, 2B, 3 and 4, chamber 3 is provided with a front wall 24 having an elongated and preferably segmental operators viewing panel 25, the front wall 24 having a horizontally extending, elongated and preferably segmental slot 26 to which is scalingly secured a flexible material or fabric 27 that is impervious to the hazardous material to be emptied from the containers 2, the fabric 27 comprising a horizontally extending, elongated mouth 28 and two spaced-apart elongated gloves or gauntlets 29 integral with the mouth and adapted to receive the operators forearms and hands.

The viewing panel 27 and elongated slot 26 are provided in a sub-assembly 30 hinged at 3 to sidewall 24 of the glove box 1 and also hinged at 32 and 33 to links 34, so that the sub-assembly may be displaced by the operator between an outer position illustrated in FIG. 2A, and an inner position illustrated in FIG. 2B, at which position the operator may unclip lid 35 of the container 2, remove the lid, and then either untie the neck of an inner bag (not shown) or slit the inner bag, following which the operator may instigate the next phase—inversion of the container 2 by further movement of the mechanism 14.

Retention of a bag within its container is ensured by a probe 36 forming part of the mechanism 14.

What I claim is:

1. A glove box comprising a chamber provided with a front wall having an operator's viewing panel, a horizontally extending, elongated slot provided in said front wall, a flexible material or fabric impervious to the hazardous material to be handled within the glove box scalingly secured to said slot, said flexible material or fabric comprising a horizontally extending, elongated mouth leading to two spaced-apart elongated gloves or gauntlets adapted, in use, to receive forearms and hands of an operator.

2. A glove box as claimed in claim 1, wherein a sub-assembly of the front wall carries said viewing panel and said elongated slot and said sub-assembly is capable within limits, of being advanced and retracted with respect to said glove box by an operator.

3. A glove box as claimed in claim 2, wherein said sub-assembly is sealingly attached to said front wall by a peripheral bellows or other flexible connector.

4. A glove box as claimed in claim 3, wherein link arrangements at opposite ends of said sub-assembly and connected between said sub-assembly and said front wall, support the weight of said sub-assembly from said front wall.

5. A glove box as claimed in claim 4, wherein each said link arrangement comprises upper and lower pairs of links, with first links of each of said pairs pivotally attached at one end to said front wall, with second links of each of said pairs pivotally attached at one end to said sub-assembly, and with tie other end of each said link secured to one another by a said sub-assembly, and with the other end or each said link secured to one another by a common pivot, all pivotal connections having a vertical axis, to provide not only for linear in and out movements, but also angled movement, as required by an operator.

6. A glove box as claimed in claim 1, wherein said slot is an oval slot.

7. A glove box as claimed in claim 1, wherein said chamber is a sealed chamber.

8. A glove box as claimed in claim 1, comprising a main chamber in which discharge of the contents of a container is effected and a loading/unloading chamber between which chambers a container is transferred.

9. A glove box as claimed in claim 8, wherein both said chambers have access doors that are interlocked whereby opening of said loading/unloading chamber door firstly permits insertion of a full container into said loading chambers with said main chamber door in a closed condition, and closing of said loading/unloading chamber door after loading permits opening of said main chamber door for transfer of the container from said loading chamber to said main chamber, with reverse of this procedure to remove an emptied container.

10. A glove box as claimed in claim 9, wherein said main chamber door is a vertical slide door.

11. A glove box as claimed in claim 10, wherein said vertical slide door is powered by a pneumatic ram.

12. A glove box as claimed in claim 9, wherein said loading/unloading chamber door is secured by shoot bolts the position of which determines whether said main chamber door can or cannot be opened.

13. A glove box as claimed in claim 9, wherein transfer of a full container from said loading/unloading chamber to said main chamber, and of an emptied container from said main chamber to said loading/unloading chamber is effected by a carriage and rail system.

14. A glove box as claimed in claim 13, wherein said carriage and rail system incorporates a powered transfer device, such as a pneumatic ram.

15. A glove box as claimed in claim 8, wherein said main chamber incorporates an elevator and inventor system for the container whereby after elevating the container in a first stage until a closure lid of said container is at a convenient working height for the operator, the operator unclips and removes said lid and opens an inner bag, after which the operator again activates said elevator and inverter system to perform a second stage of further elevating and then inverting the container to achieve discharge of the contents.

16. A glove box as claimed in claim 15, wherein said elevator and inverter system incorporates a rod or probe adapted to project into an opened bag to ensure retention of the bag within the container during inverted discharge.

17. A glove box as claimed in claim 15, wherein said elevator incorporates a “U”-shaped cradle so as not to impede discharge of the material of the containers.
